(19) United States
(12) Patent Application Publication
(10) Pub. No.: US 2016/0211798 A1
(43) Pub. Date: Jul. 21, 2016

(54) PHOTOVOLTAIC MODULE WITH IMPROVED CONNECTOR TECHNOLOGY

(71) Applicant: COMMISSARIAT A L'ENERGIE ATOMIQUE ET AUX ENERGIES ALTERNATIVES, Paris (FR)

(72) Inventors: Eric Pilat, Brison-Saint-Innocent (FR); Nicolas Chaintreuil, Montmelian (FR); Cyril Ginet, Saint Victor de Cessieu (FR)

(73) Assignee: COMMISSARIAT A L'ENERGIE ATOMIQUE ET AUX ENERGIES ALTERNATIVES, Paris (FR)

(21) Appl. No.: 15/023,810

(22) PCT Filed: Sep. 16, 2014
(86) PCT No.: PCT/EP2014/069699

§ 371 Date: Mar. 22, 2016

(30) Foreign Application Priority Data
Sep. 23, 2013 (FR) 13 59099

(51) Int. Cl. H02S 40/36; H01R 13/71

(52) U.S. Cl. CPC H02S 40/36; H01R 13/71

(57) ABSTRACT

A photovoltaic module (10a) comprises an electrical connector of a first type (12) arranged so as to be able to cooperate with an electrical connector of a second type (13) of a first adjacent photovoltaic module (10b) to establish an electrical connection between the photovoltaic modules (10a, 10b). The module (10a) comprises a rotary element (121), the rotation of which produces the switchover of the electrical connector of the first type (12) from an active configuration in which the electrical connector of the first type (12) makes it possible to establish an electrical link between the photovoltaic modules (10a, 10b) to an inactive configuration in which the possibility of establishing the electrical link is disabled.

### TECHNICAL FIELD OF THE INVENTION

The invention relates to a photovoltaic module comprising an electrical connector of a first type arranged so as to be able to cooperate with an electrical connector of a second type of another adjacent photovoltaic module to establish an electrical connection between said photovoltaic modules.

Also the subject of the invention is a photovoltaic installation which comprises such photovoltaic modules arranged adjacent to one another on their edges in their frames.

### STATE OF THE ART

In the following text, the term “photovoltaic module” preferentially corresponds to a solar sensor of photovoltaic panel type having a plurality of photovoltaic cells mechanically joined and electrically connected together to form a unitary assembly, generally of planar form.

Depending on the electrical power sought, it is known practice to connect a plurality of photovoltaic modules together in series and/or in parallel via electrical cables equipped with standard electrical connectors. There are numerous types of standard connectors. The cable connection makes it possible to establish an electrical connection between the photovoltaic modules. Through its flexibility, it allows for a good compensation of alignment defects between the modules and any differential expansions likely to occur between the modules joined together throughout the use, for example throughout an installation on a roof.

A photovoltaic module 50 known from the prior art is described hereinbelow with reference to FIG. 1. The photovoltaic module 50 comprises photovoltaic cells 51, a connection housing 52 from which exit connecting cables 53, 55 at the ends of which there are male and female connectors 54, 56. The cables 53, 55 are connected to positive and negative terminals of the module 50 inside the housing 52, which ensures protection for these connections and for the terminals.

With such modules 50, it is possible to produce a photovoltaic installation comprising a plurality of such modules 50 electrically mounted in series and/or in parallel by being linked to one another via the connecting cables 53 and 55 and via the connectors 54 and 56.

This solution is not however entirely satisfactory because of the major risks that are encountered in practice, listed hereinbelow:
risk of total or partial breaking of the cables during transportation or when setting up the photovoltaic installation,
risk of electrification or of electrocution during power-up or maintenance,
risk of dangerous occurrence of an electrical arc, even susceptible to fire,
problems of malfunctioning and of loss of power,
the connectors being directly linked to the photovoltaic module via the cables 53 and 55 and the connection housing 52, there is a very high risk of electrification in the case where the user accidentally inserts any type of electrically conductive part into the connectors, such as a nail or a screwdriver.

Moreover, this prior art solution presents the following main problems:
problem of penetration of moisture at the point where the cover of the connection housing 52 is fixed to the rest of the housing, at the link between each cable 53 and 55 and the electrical terminals housed in the housing 52, at the fixing of these terminals to the photovoltaic module 50 and at the electrical link between the photovoltaic module 50 and the electrical connection linking the terminals and the module 50; this causes problems of acceleration of the degradation processes and the phenomena of corrosion and hydrolysis generated by this penetration of moisture are the major causes of degradation of the photovoltaic modules recorded,
problem of loss of time at the time of installation, for connecting and stowing away the cables 53, 55,
problem of loss of efficiency linked to an energy dissipation in the cables 53, 55,
problem of an excessively great need for human intervention, adding a risk of error or of bad connections, likely to jeopardize installation,
problem of crimping of the connectors 54, 56 onto the cables 53, 55 often done by the installer, inducing risks for said installer and for the installation in the case where the connection is done inappropriately.

The document WO 2012/077393 A1 describes a solution that only partially addresses these problems, namely an installation with a plurality of photovoltaic modules joined together in a number of parallel rows and electrically connected together in series. On its bottom face, each module comprises a housing in which a number of electrical connections are made. The cells of a module are permanently electrically connected to a first connector while the cells of the adjacent module are permanently electrically connected to a second connector. The first and second connectors can be fitted into one another to connect the two modules. The first connector comprises an electrical contact-forming insert spike, housed in a housing which comprises, on its outer surface, a radial pin. The second connector comprises an electrical contact-forming insert sleeve of a form complementing the insert spike and a groove comprising a straight part and a helical part. The pin slips in the groove. By rectilinearly inserting the first connector into the second connector in a state in which the pin is at the end of the straight part of the groove, the assembly adopts a first configuration in which the two contacts are protected from the outside but are not in electrical contact with one another. Then, it is necessary to rotate the housing of the first connector relative to the housing of the second connector, according to a helical guidance imposed by the slipping of the pin in the helical part of the groove, to bring the assembly into a second configuration in which the two contacts are protected from the outside and are in electrical contact with one another. The first electrical connector is always electrically connected with the module on which it is mounted, regardless of the angular position adopted by its housing. Similarly, the second connector is always electrically connected with the module on which it is mounted.

### OBJECT OF THE INVENTION

The aim of the invention is to provide a photovoltaic module and a photovoltaic installation that make it possible to remedy problems described previously and that improve the solutions known from the prior art.

In particular, the invention aims to propose a photovoltaic module and a photovoltaic installation that make it possible to:
simplify the work of the installer and reduce the installation time,
improve (reliabilize, reduce the quantity of energy dissipated, etc.) the electrical connection technology between two photovoltaic modules linked together,
eliminate the risks associated with breakage of the cables,
totally eliminate the risks of electrification during maintenance,
reduce the number of steps during the assembly of the photovoltaic modules,
minimize the risk of penetration of moisture into the photovoltaic module.

These objectives can be achieved by all or some of the attached claims, and in particular by a photovoltaic module comprising an electrical connector of a first type arranged so as to be able to cooperate with an electrical connector of a second type of a first adjacent photovoltaic module to establish an electrical connection between these two photovoltaic modules, the module comprising a rotary element, the rotation of which produces the switchover of the electrical connector of the first type from an active configuration in which the electrical connector of the first type makes it possible to establish an electrical link between the photovoltaic modules to an inactive configuration in which the possibility of establishing the electrical link is disabled, in which the rotary element consists of a mobile part of the electrical connector of the first type mounted to pivot such that the switchover of the electrical connector of the first type from one configuration to the other is effected by a pivoting movement of its mobile part over a given angular travel, the active configuration corresponding to a first angular position of the mobile part in which an electrical connection is established between the photovoltaic module and the electrical connector of the first type and the inactive configuration corresponding to a second angular position of the mobile part in which said electrical connection is not established.

### BRIEF DESCRIPTION OF THE DRAWINGS

Other advantages and features will emerge more clearly from the following description of particular embodiments of the invention given as nonlimiting examples and represented in the attached drawings, in which:

FIG. 1 shows a perspective illustration of a photovoltaic module according to the prior art,

FIG. 2 shows a schematic cross section of a photovoltaic installation with three photovoltaic modules according to the invention joined together,

FIGS. 3 and 4 represent the principle of operation of the electrical connectors, in a schematic cross section of the joining zone between two adjacent modules, respectively in their inactive configurations and in their active configurations,

FIGS. 5 and 6 show, in perspective, an example of a module according to the invention respectively in an exploded view and in the assembled state,

FIG. 7 illustrates the detail A of FIG. 6,

FIGS. 8 and 9 represent an example of construction of the electrical connectors of the first type and of the second type, in a schematic cross section of the joining zone between two adjacent modules, respectively in their inactive configurations and in their active configurations.

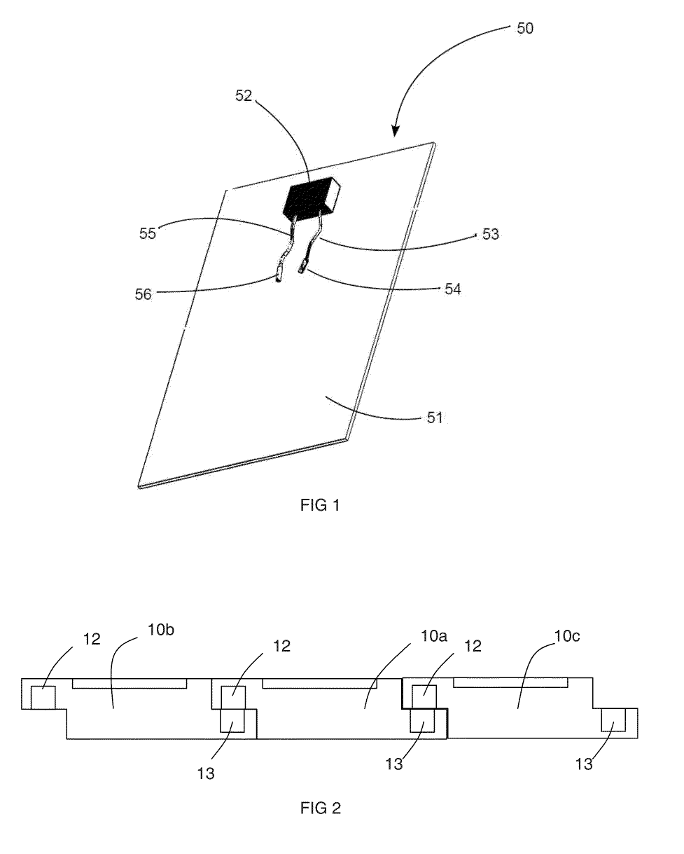

### DESCRIPTION OF PREFERENTIAL EMBODIMENTS OF THE INVENTION

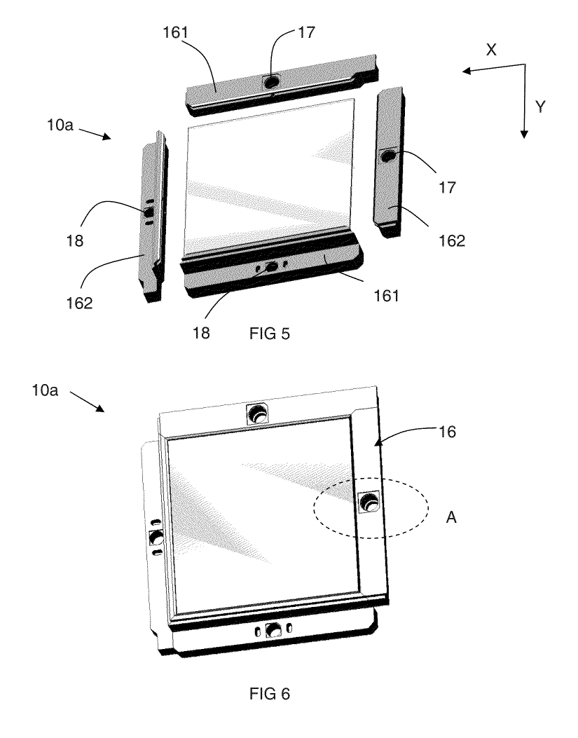

In FIGS. 2 to 9, a photovoltaic module 10a comprises at least one electrical connector of a first type 12. The module 10a also comprises at least one electrical connector of a second type 13.

A photovoltaic installation comprises at least two distinct photovoltaic modules joined together so as to be arranged adjacent at one of their edges. Thus, FIG. 2 represents, without being limiting, a photovoltaic installation comprising the photovoltaic module 10a described above, a first adjacent photovoltaic module referenced 10b arranged adjacent to the module 10a at a left lateral edge of the module 10a and a second adjacent photovoltaic module 10c arranged adjacent to the module 10a at a right lateral edge of the module 10a. The three photovoltaic modules 10a, 10b and 10c each comprise at least one electrical connector of the first type 12 and at least one electrical connector of the second type 13, all identical from one module to the other and operating in the manner described later to ensure the electrical connection between the adjacent photovoltaic modules. It should also be specified that the photovoltaic installation may comprise any number of photovoltaic modules, for example greater than 3.

Generally, the electrical connector of the first type 12 of a given photovoltaic module is arranged so as to be able to cooperate with the electrical connector of the second type 13 of another photovoltaic module when these two modules are joined together so as to be adjacent.

The first adjacent photovoltaic module 10b comprises at least one electrical connector of the first type 12 identical to that of the module 10a and at least one electrical connector of the second type 13 identical to that of the module 10a. The second adjacent photovoltaic module 10c comprises at least one electrical connector of the first type 12 identical to that of the module 10a and of the module 10b and at least one electrical connector of the second type 13 identical to that of the module 10a and of the module 10b.

The electrical connector of the first type 12 of the photovoltaic module 10a is arranged so as to be able to cooperate with the electrical connector of the second type 13 of the first adjacent photovoltaic module 10b which is arranged adjacent to the left edge of the photovoltaic module 10a. The electrical connector of the second type 13 is distinct from the connector of the first type 12 and they belong to distinct and adjacent photovoltaic modules, but these connectors of the first and second types 12, 13 are provided to be able to cooperate with one another when the two modules 10a, 10b are mechanically joined to one another. The first adjacent photovoltaic module 10b is distinct from the photovoltaic module 10a in as much as they are preferably each of a single piece and can be handled separately. The first adjacent photovoltaic module 10b is designed so as to cooperate with the module 10a in as much as they can be joined to one another by two edges facing one another and they can cooperate electrically via the electrical connectors of the first and second types 12, 13. The cooperation between the connectors 12, 13 has the effect of making it possible to establish an electrical connection between the photovoltaic module 10a and the photovoltaic module 10b.

The electrical connector of the second type 13 of the photovoltaic module 10a is arranged so as to be able to cooperate with the electrical connector of the first type 12 of the second adjacent photovoltaic module 10c which is therefore adjacent to the photovoltaic module 10a. The cooperation between the connector of the second type 13 of the module 10a and the connector of the first type 12 of the second adjacent module 10c makes it possible to establish an electrical link between the photovoltaic modules 10a and 10c.

In the present document, the term “photovoltaic module” preferentially corresponds to a solar sensor of photovoltaic panel type having a plurality of photovoltaic cells mechanically joined together and electrically connected to one another to form a unitary assembly, generally of planar form.

The term “cooperate” should preferably be interpreted as meaning “be in physical contact with one another and in direct electrical contact with one another”.

The photovoltaic module 10a comprises a rotary element, the rotation of which produces the switchover of the electrical connector of the first type 12 of the module 10a from an active configuration in which this electrical connector of the first type 12 makes it possible to establish an electrical link (via the electrical connector of the second type 13 of the module 10b with which it cooperates) between the photovoltaic module 10a and the photovoltaic module 10b to an inactive configuration in which the possibility of establishing this electrical link is inhibited.

The operation of the electrical connector of the first type 12 of the photovoltaic module 10c is identical: the second adjacent module 10c comprises a rotary element, the rotation of which produces the switchover of the electrical connector of the first type 12 of the module 10c from an active configuration in which this electrical connector of the first type 12 makes it possible to establish an electrical link (via the electrical connector of the second type 13 of the module 10a with which it cooperates) between the photovoltaic module 10c and the photovoltaic module 10a to an inactive configuration in which the possibility of establishing this electrical link is inhibited.

Preferentially, and as illustrated in FIGS. 3, 4, 8 and 9, this rotary element consists of a mobile part 121 of the electrical connector of the first type 12 of the module 10a mounted to pivot about a pivoting axis D1 relative to the photovoltaic module 10a such that the switchover of the electrical connector of the first type 12 from one configuration to the other is effected by a pivoting movement F1 of its mobile part 121 over a given angular travel. The active configuration corresponds to a first angular position of the mobile part 121 at one end of the total angular travel in which an electrical connection is established between the photovoltaic module 10a and the electrical connector of the first type 12 of the module 10a. The inactive configuration corresponds to a second angular position of the mobile part 121 at the opposite end of the total angular travel in which the electrical connection between the photovoltaic module 10a and the electrical connector of the first type 12 of the module 10a is not established. As an example, the total angular travel between the first and second angular positions is 90 degrees, such that the mobile part 121 acts as a quarter turn.

The operation of each electrical connector of the first type 12 of the modules 10b and 10c is identical.

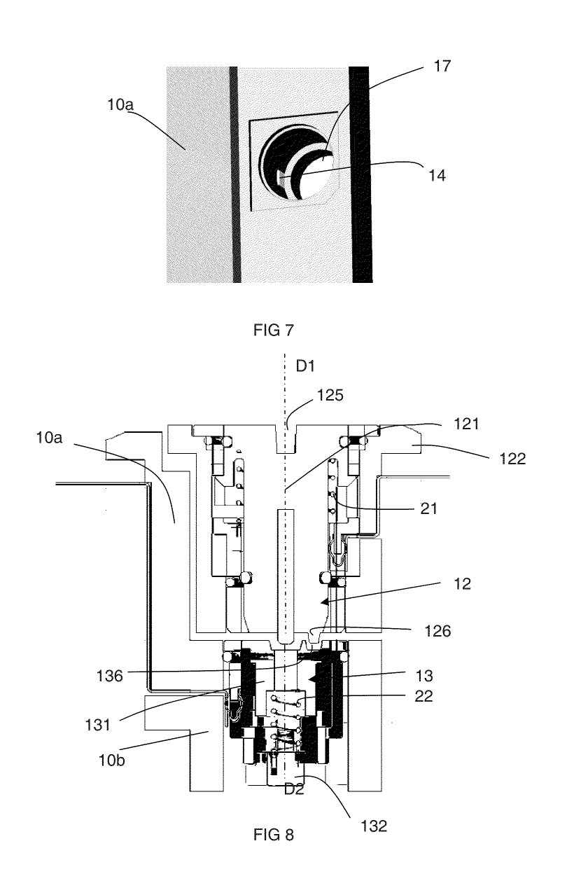

Preferentially, for example with reference to FIGS. 7 and 9, the photovoltaic module 10a comprises a first electrically conductive element 14 arranged so as to establish the electrical connection between the photovoltaic module 10a and the mobile part 121 of the electrical connector of the first type 12 of the module 10a in the first position of its mobile part 121. Although the nature of the first electrically conductive element 14 can be of any kind, it is notably in the form of a first electrically conductive blade, that can be bent in such a way that it is automatically in contact with the mobile part 121 when the latter occupies its first position.

Identically, the photovoltaic module 10b also comprises a first electrically conductive element 14 suitable for establishing the electrical connection between the photovoltaic module 10b and the mobile part of the electrical connector of the first type borne by the module 10b. The same applies for the photovoltaic module 10c.

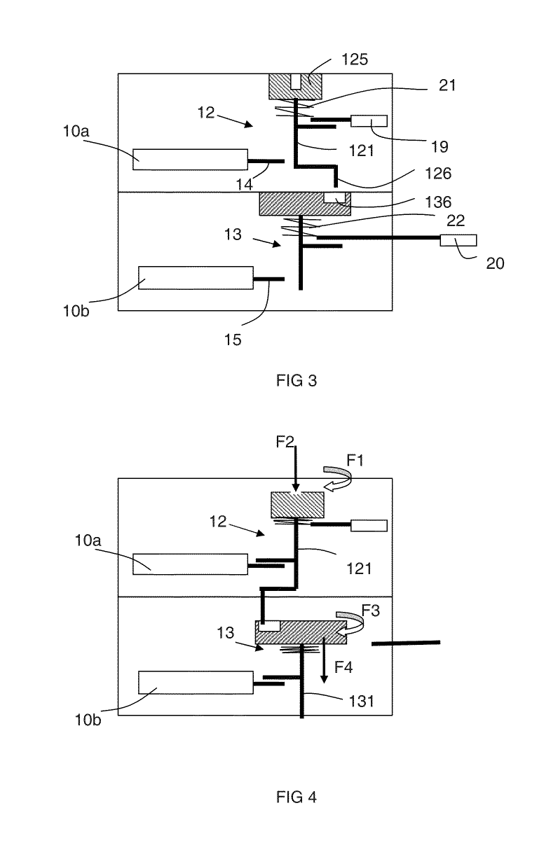

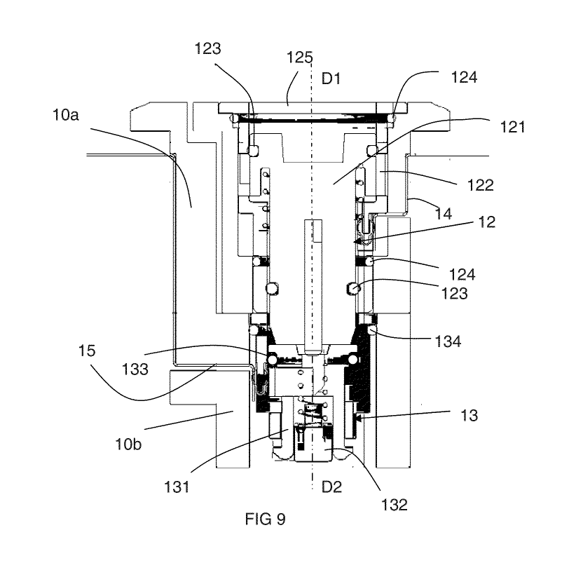

FIG. 3 schematically illustrates the principle of operation of the connector of the first type 12 of the module 10a in the second angular position of its mobile part 121. By contrast, FIG. 4 schematically illustrates the principle of operation of this connector of the first type 12 in the first angular position of its mobile part 121 which is then electrically linked with the photovoltaic module 10a, via the first electrically conductive element 14 of the module 10a. The same configurations are respectively adopted in FIGS. 8 and 9.

According to one embodiment the electrical connector of the first type 12 of the photovoltaic module 10a comprises a fixed part 122 mounted on the rest of the photovoltaic module 10a so as to be rotationally immobile about the pivoting axis D1 of the mobile part 121 of this electrical connector of the first type 12. The principle is then identical for the electrical connectors of the first type 12 which belong to the modules 10b, 10c.

Generally, the fixed part 122 of an electrical connector of the first type 12 is intended to ensure a function of fixing of the electrical connector of the first type 12 to the corresponding photovoltaic module 10a, 10b, 10c and a function of guiding of the mobile part 121 of this connector in its pivoting movement. However, the fixed part 122 could be absent by ensuring, in this case, a pivot-wise mounting of the mobile part 121 directly on the corresponding photovoltaic module 10a, 10b, 10c.

Preferentially, each module 10a, 10b, 10c comprises a first sealing means 123 ensuring an airtight and watertight sealing function, interposed between the mobile part 121 and the fixed part 122 of the electrical connector of the first type 12 and a second sealing means 124 ensuring an identical function and interposed between the fixed part 122 of the electrical connector of the first type 12 and the rest of the corresponding photovoltaic module 10a, 10b, 10c. Each sealing means 123, 124 can be of any kind offering the function sought and can notably be of the lip seal or O-ring seal type.

It is advantageous to arrange for the pivoting axis D1 of the mobile part 121 of the electrical connector of the first type 12 to be at right angles to the longitudinal direction X and to the lateral direction Y which correspond respectively to the length and to the width of the first photovoltaic module 10a. This arrangement allows for the handling of the connectors 12, 13 to be very simple once the photovoltaic modules 10a, 10b, 10c are joined together. The same applies for the electrical connectors of the first type 12 of the photovoltaic modules 10b, 10c. However the pivoting axis D1 for each electrical connector of the first type 12 can have any orientation.

Preferentially, the electrical connector of the second type 13 of the photovoltaic module 10a comprises a pivotingly mobile part 131 mounted to pivot about an axis D2 relative to the photovoltaic module 10a over a given angular travel such that this electrical connector of the second type 13 varies, by pivoting of its mobile part 131, between:
an active configuration adopted in a first angular position of the mobile part 131 in which the electrical connector of the second type 13 makes it possible to establish an electrical link (via the electrical connector of the first type 12 of the module 10c with which it cooperates) between the photovoltaic module 10a and the second adjacent photovoltaic module 10c and in which an electrical connection is established between the photovoltaic module 10a and the electrical connector of the second type 13 of the module 10a,
and an inactive configuration adopted in a second angular position of the mobile part 131 in which the possibility of establishing the electrical link between the two photovoltaic modules 10a, 10c is disabled and in which the electrical connection between the photovoltaic module 10a and the electrical connector of the second type 13 of the module 10a is not established.

All the functional and structural characteristics associated with the electrical connector of the second type 13 which belongs to the photovoltaic module 10a are identical for the electrical connector of the second type 13 which belongs to the photovoltaic module 10b and for that which belongs to the photovoltaic module 10c. Thus, the electrical connector of the second type 13 of the first adjacent photovoltaic module 10b operates in the same way as the electrical connector of the second type 13 of the photovoltaic module 10a. Only the electrical connector of the second type 13 of the first adjacent photovoltaic module 10b is illustrated in detail in FIGS. 3, 4 and 8 and 9, such that all the functional and structural characteristics are represented in application thereto. This further makes it possible to illustrate the cooperation of the electrical connector of the second type 13 of the module 10b with the electrical connector of the first type 12 of the module 10a.

The electrical connector of the second type 13 of the first adjacent photovoltaic module 10b therefore also comprises a pivotingly mobile part 131 mounted to pivot about an axis D2 relative to the rest of the photovoltaic module 10b over a given angular travel such that this electrical connector of the second type 13 varies, by pivoting of its mobile part 131, between:
an active configuration (FIGS. 4 and 9) adopted in a first angular position of the mobile part 131 in which the electrical connector of the second type 13 makes it possible to establish an electrical link (via the electrical connector of the first type 12 of the module 10a with which it cooperates) between the photovoltaic module 10a and the first adjacent photovoltaic module 10b and in which an electrical connection is established between the photovoltaic module 10b and the electrical connector of the second type 13 of the module 10b,
and an inactive configuration (FIGS. 3 and 8) adopted in a second angular position of the mobile part 131 in which the possibility of establishing the electrical link between the photovoltaic module 10a and the first adjacent photovoltaic module 10b is inhibited and in which the electrical connection between the photovoltaic module 10b and the electrical connector of the second type 13 of the module 10b is not established.

It is clear that the electrical connector of the second type 13 of the second adjacent photovoltaic module 10c works in a similar way via an electrical connector of the first type of another photovoltaic module not represented and with which it cooperates. Similarly, the electrical connector of the first type 12 of the first adjacent module 10b operates in a way similar to those of the other modules, via an electrical connector of the second type of another photovoltaic module not represented and with which it cooperates.

The photovoltaic module 10a comprises a second electrically conductive element 15 (not illustrated) arranged in such a way as to establish the electrical connection between the photovoltaic module 10a and the mobile part 131 of the electrical connector of the second type 13 of the module 10a in the first position of its mobile part 131. Although the nature of the second electrically conductive element 15 can be of any type, it notably takes the form of a second electrically conductive blade, that should be bent so that it is automatically in contact with the mobile part 131 when the latter occupies its first angular position.

Similarly, the first adjacent photovoltaic module 10b also comprises such a second electrically conductive element 15 (visible in the figures) arranged so as to establish the electrical connection between the photovoltaic module 10b and the mobile part 131 of the electrical connector of the second type 13 in the first position of its mobile part 131. The second adjacent photovoltaic module 10c also comprises such a second electrically conductive element 15 used in association with the mobile part of the electrical connector of the second type of the module 10c.

FIG. 3 schematically illustrates the principle of operation of the electrical connector of the second type 13 of the module 10b in the second angular position of its mobile part 131. By contrast, FIG. 4 schematically illustrates the principle of operation of the connector of the second type 13 of the module 10b in the first angular position of its mobile part 131 which is, in this case, electrically linked with the photovoltaic module 10b, via the second electrically conductive element 15. The same configurations are respectively adopted in FIGS. 8 and 9.

According to an advantageous embodiment, the electrical connector of the second type 13 of the photovoltaic module 10a comprises a fixed part 132 mounted on the rest of the photovoltaic module 10a so as to be rotationally immobile about the pivoting axis D2 of the mobile part 131 of this electrical connector of the second type 13. The principle is then identical for the electrical connectors of the second type 13 which belong to the modules 10b, 10c.

Generally, the fixed part 132 of each electrical connector of the second type 13 is intended to ensure a function of fixing of the electrical connector of the second type 13 onto the corresponding photovoltaic module 10a, 10b, 10c and a function of guiding of its mobile part 131 in its pivoting movement. However, the fixed part 132 could be absent by ensuring, in this case, a pivot-wise mounting of the mobile part 131 directly on the corresponding photovoltaic module 10a, 10b, 10c.

Preferentially, each module 10a, 10b, 10c comprises a third sealing means 133 ensuring an airtight and watertight sealing function interposed between the mobile part 131 and the fixed part 132 of the electrical connector of the second type 13 and a fourth sealing means 134 ensuring an identical function and interposed between the fixed part 133 of the electrical connector of the second type 13 and the rest of the corresponding photovoltaic module 10a, 10b, 10c. Each sealing means 133, 134 can be of any kind with the function sought and can notably be of lip seal or O-ring seal type.

The use of lip seals to form the sealing means 123, 124, 133, 134 makes it possible to reduce the forces needed to move the mobile parts 121, 131 and makes it possible to more easily take up any defects of form in the different parts.

As previously and for the same reasons, it is advantageous to provide for the pivoting axis D2 of the mobile part 131 of the electrical connector of the second type 13 of the module 10a to be at right angles to the directions X, Y corresponding to the length and to the width of the photovoltaic module 10a. The same applies for the electrical connectors of the second type 13 of the photovoltaic modules 10b, 10c. However, the pivoting axis D2 for each electrical connector of the second type 13 can have any orientation.

Preferentially, the electrical connector of the first type 12 and/or the electrical connector of the second type 13 of the module 10a is arranged on a frame 16 encircling the photovoltaic module 10a. The same applies for the connector of the first type 12 and/or the connector of the second type 13 of the module 10b on another frame 16 encircling the first adjacent photovoltaic module 10b. Similarly, the electrical connector of the first type 12 and/or the electrical connector of the second type 13 of the module 10c is arranged on a third frame 16 encircling the second adjacent photovoltaic module 10c. In other words, each photovoltaic module 10a, 10b, 10c comprises a frame 16 which encircles it. The result thereof is a reduction in the number of assembly steps compared to the prior art solution previously explained by virtue of an advantageous incorporation of the mounting of the connectors of the first and second types 12, 13 in the process of production of the frames 16.

Preferentially and with reference to FIGS. 5 to 7, each frame 16 can, for this purpose, comprise a first recess 17 in which is housed each electrical connector of the first type 12 and/or a second recess 18 in which is housed each electrical connector of the second type 13. Each first recess 17 and each second recess 18 notably has a circular form in order to simplify the manufacture, although any other form can be envisaged according to the requirements.

As illustrated, each frame 16 is formed by two longitudinal elements 161 oriented in the longitudinal direction X of the photovoltaic module that it encircles and by two lateral elements 162 oriented in the lateral direction Y of the photovoltaic module that it encircles, assembled two by two so as to form a frame of rectangular form. A first recess 17 is formed in one such lateral element 162 and another first recess 17 is formed in one such longitudinal element 161, directly assembled together. A second recess 18 is formed in the other such lateral element 162 and another second recess 18 is formed in the other such longitudinal element 161, directly assembled together.

From the above, it can be seen that the photovoltaic installation comprises the photovoltaic module 10a and the first adjacent photovoltaic module 10b as described above, arranged adjacent to one another on their frames 16. The module 10a comprises at least one electrical connector of the first type 12 whereas the module 10b comprises at least one electrical connector of the second type 13. This installation varies between:
a first electrical configuration (FIGS. 4 and 9) in which the electrical link is established between the photovoltaic modules 10a, 10b adopted in the active configuration of the electrical connector of the first type 12 and when the electrical connector of the first type 12 and the electrical connector of the second type 13 are in physical and electrical contact,
and a second electrical configuration (FIGS. 3 and 8) in which the electrical link is not established between the photovoltaic modules 10a, 10b adopted in the inactive configuration of the electrical connector of the first type 12 and/or when the electrical connector of the first type 12 and the electrical connector of the second type 13 are not in physical and electrical contact.

In the first electrical configuration of the photovoltaic installation and with reference to FIGS. 4 and 9, the mobile part 121 of the electrical connector of the first type 12 of the module 10a preferentially occupies its first angular position in which an electrical connection is established between the photovoltaic module 10a and the electrical connector of the first type 12 of the module 10a and the mobile part 131 of the electrical connector of the second type 13 of the first adjacent module 10b preferentially occupies its first angular position in which an electrical connection is established between the photovoltaic module 10b and the electrical connector of the second type 13 of the module 10b. The mobile parts 121, 131 of the electrical connectors of the first and second types 12, 13 are in physical and electrical contact with one another. The electrical connector of the first type 12 is notably connected electrically to a positive terminal of the photovoltaic module 10a. The electrical connector of the second type 13, for its part, is notably connected electrically to a negative terminal of the photovoltaic module 10b.

In the second electrical configuration of the photovoltaic installation and with reference to FIGS. 3 and 8, the mobile part 121 of the electrical connector of the first type 12 of the module 10a preferentially occupies its second angular position in which the electrical connection is not established between the photovoltaic module 10a and the electrical connector of the first type 12 of the module 10a and/or the mobile part 131 of the electrical connector of the second type 13 of the first adjacent module 10b occupies its second angular position in which the electrical connection is not established between the photovoltaic module 10b and the electrical connector of the second type 13. Alternatively or in combination, in the second electrical configuration of the photovoltaic installation and with reference to FIGS. 3 and 8, the mobile parts 121, 131 of the electrical connectors of the first and second types 12, 13 are not in physical and electrical contact.

Preferentially, the photovoltaic module 10a and the first adjacent photovoltaic module 10b respectively comprise first and second joining elements independent of the electrical connectors of the first and second types 12, 13 and that cooperate with one another so as to mechanically mutually secure together or detach the photovoltaic modules 10a, 10b depending on a relative positioning such that the pivoting axis D1 of the mobile part 121 of the electrical connector of the first type 12 of the module 10a is aligned with the pivoting axis D2 of the mobile part 131 of the electrical connector of the second type 13 of the module 10b.

In a particular embodiment, the electrical connectors of the first and second types 12, 13 are arranged such that the implementation of a mechanical detachment between the photovoltaic modules 10a, 10b by the first and second joining elements automatically provokes the switchover of the photovoltaic installation to the second electrical configuration, notably by the elimination of any physical and electrical contact between the mobile parts 121, 131 of the electrical connectors of the first and second types 12, 13 respectively secured to the modules 10a, 10b. Therefore, in this embodiment, the result thereof is an automatic elimination of the physical and electrical contact between the electrical connectors of the first and second types 12, 13 as soon as the joining elements are maneuvered to their state ensuring the mechanical separation of the two adjacent modules 10a, 10b.

Alternatively or in combination, the first and second joining elements can mechanically secure the photovoltaic modules 10a, 10b together independently of the choice of the first and second electrical configurations of the photovoltaic installation. Thus, the joining elements can in this variant be actuated to their state ensuring the mechanical securing together of the two adjacent modules 10a, 10b without the electrical connectors of the first and second types 12, 13 being placed in physical and electrical contact and/or without the mobile parts 121, 131 of the electrical connectors of the first type and of the second type 12, 13 being pivoted to their first positions of electrical connection (respectively via the electrically conductive elements 14, 15) with their respective photovoltaic modules 10a, 10b.

Such joining elements make it possible to separate the assembly function and of the two adjacent photovoltaic modules and the function of electrical connection between the photovoltaic modules. They can notably be formed on the frames 16 of the two modules 10a, 10b and can be of any kind suited to the function sought and can for example comprise mechanical positioners such as ball screws or cone systems conferring a relative positioning tolerance on the two modules 10a, 10b in all three dimensions.

In a first variant, the placing of the electrical connectors of the first and second types 12, 13 in physical and electrical contact automatically results from the simple implementation of the first and second joining elements to their state ensuring the mechanical securing together of the photovoltaic modules 10a, 10b: the simple action of mechanically securing the two adjacent modules 10a, 10b via the first and second joining elements is sufficient to establish the physical and electrical contact of the electrical connectors of the first and second types 12, 13, and is so regardless of the angular positions adopted by their mobile parts 121, 131 about their respective pivoting axes D1, D2.

In a second variant, this placing of the electrical connectors of the first and second types 12, 13 in physical and electrical contact is additionally conditional on the implementation of the sliding movement F2 of the mobile part 121 of the electrical connector of the first type 12 relative to the mobile part 131 of the electrical connector of the second type 13 (which then remains fixed by sliding along its pivoting axis D2), this sliding movement F1 being automatically stopped by virtue of the physical contact made between the mobile part 121 of the electrical connector of the first type 12 and the mobile part 131 of the electrical connector of the second type 13 and at the moment of that contact.

Preferentially and with reference to FIG. 4, the electrical connector of the first type 12 comprises an actuation member 125 accessible from outside the photovoltaic module 10a and arranged so as to allow the application to this actuation member 125 of a driving force (for example via a screwdriver) provoking a pivoting movement F1 of the mobile part 121 of the electrical connector of the first type 12 from its second position to its first position. It may be advantageous to provide for the electrical connectors of the first and second types 12, 13 to comprise cooperation elements 126, 136, notably of complementary forms of male-female type, ensuring that this pivoting movement F1 of the mobile part 121 of the electrical connector of the first type 12 of the module 10a provokes a pivoting movement F3 of the mobile part 131 of the electrical connector of the second type 13 of the module 10b from its second position to its first position, the mobile part 131 of the electrical connector of the second type 13 being driven by the mobile part 121 of the electrical connector of the first type 12 at the level of the cooperation elements 126, 136. Thus, the simple manipulation of the actuation member 125 allows for the variation of the photovoltaic installation from one electrical configuration to the other without the need to provide a specific action on the electrical connector of the second type 13 of the module 10b.

Advantageously, the mobile part 121 of the electrical connector of the first type 12 can be mounted to slide along its pivoting axis D1 so as to be able to be translated over a sliding travel in opposition to the action of a first return element 21 (visible in FIGS. 3 and 8) of the module 10a stressing the mobile part 121 to a rest position. The rest position corresponds, for example, to an upper position in which the first return element 21, which is a spring for example, is stressed little or not at all in compression. This variant offers the advantage of allowing for the electrical connector of the first type 12 to be arranged in such a way that the pivot-wise driving F1 of the mobile part 121 of the electrical connector of the first type 12 by the actuation member 125 is conditional on the implementation of a sliding movement F2 of the mobile part 121 of the electrical connector of the first type 12 from its rest position. This reinforces the general safety of the assembly by arranging for the switchover of the installation to the first electrical configuration to be conditional on the deliberate implementation of the sliding movement F2.

Preferentially and with reference to FIG. 4, the mobile part 131 of the electrical connector of the second type 13 can be mounted to slide along its pivoting axis D2 so as to be able to be translated over a sliding travel in opposition to the action of a second return element 22 of the module 10b stressing the mobile part 131 towards a rest position. The rest position corresponds for example to an upper position in which the second return element 22, which is a spring for example, is stressed little or not at all in compression. This variant offers the advantage that the electrical connectors of the first and second types 12, 13 can ensure that the sliding movement F2 of the mobile part 121 of the electrical connector of the first type 12 from its rest position provokes a sliding movement F4 of the mobile part 131 of the electrical connector of the second type 13 from its rest position. The pivot-wise driving of the mobile part 131 of the electrical connector of the second type 13 by the mobile part 121 of the electrical connector of the first type 12 is conditional on the implementation of the sliding movement F4 of the mobile part 131 of the electrical connector of the second type 13 from its rest position. As long as the electrical connector 13 is in its rest position under the return action of the element 22, the pivoting movement F3 of the mobile part 121 is prohibited for the switchover from the second position to the first position, or vice-versa, preventing the switchover of the installation to the first electrical configuration.

In practice, the installer positions the modules 10a, 10b visually using joining elements which allow a play of a few millimetres in order to facilitate the placement and leave a minimum of freedom between the modules 10a, 10b (expansion, dimensional tolerances, etc.). The preceding solution confers an easy integration of the electrical connector technology in the frames 16 which encircle the photovoltaic modules 10a, 10b. With a tool of screwdriver type, the installer turns the actuation member 125 to switch (movements F1, F3) the mobile parts 121, 131 from their second angular positions to their first angular positions, while exerting a pressure (movement F2) on the connector of the first type 12. The latter is engaged in the connector of the second type 13 via the cooperation elements 126, 136 and drives it in rotation (F3) and downwards (F4). In the down position opposite their rest positions, the mobile parts 121, 131 of the connectors of the first and second types 12, 13 in electrical and mechanical contact with one another establish an electrical contact between the positive terminal of the photovoltaic module 10a and the negative terminal of another photovoltaic module 10b.

More specifically, the electrical contact is not established between the electrically conductive element 14 and the mobile part 121 when the mobile part 121 is in its second angular position. This electrical contact is made possible by a manoeuvre F1, F2 of the member 125 and of the mobile part 121. A vertical pressure on the mobile part 121 allows it to slide F2 downwards over a travel of a few millimetres which then allows its pivoting movement F1 which in turn allows the switchover to the first angular position of the mobile part 121, which establishes the electrical connection between the electrically conductive element 14 and the mobile part 121. When the electrical connector of the first type 12 is maneuvered, it comes into contact on the electrical connector of the second type 13 and also pivotingly drives its mobile part 131 upon its own rotation. This allows the mobile part 131 to switch over from the second angular position to the first angular position. This establishes the electrical contact between the electrically conductive element 15 and the mobile part 131. The electrical connection is then established between the two adjacent photovoltaic modules 10a, 10b.

Throughout the above, a given photovoltaic module is formed as the assembly formed on the one hand by the lamination comprising the photovoltaic cells, the encapsulating material and the glass plates, and on the other hand the frame and the electrical connector(s).

In addition to those already mentioned, the solution previously described offers the following advantages:
simplicity and safety for the installer who powers on with a wrench (or a screwdriver),
possibility of mechanically linking the photovoltaic modules without electrically connecting them,
possibility of electrically disconnecting the photovoltaic modules from one another before mechanically separating them,
the connector technology is implemented in the factory, so there is an obvious consequential reliabilization by dispensing with human variables,
improved security by virtue of the elimination of any risk of accessing the electrically live elements of the photovoltaic modules,
seal-tightness ensured by a defined assembly of market-standard seals having proven quality,
improved safety.

1. Photovoltaic module comprising:
an electrical connector of a first type arranged so as to be able to cooperate with an electrical connector of a second type of a first adjacent photovoltaic module to establish an electrical connection between the photovoltaic module and the first adjacent photovoltaic module, and
a rotary element, the rotation of which produces a switchover of the electrical connector of the first type from an active configuration in which the electrical connector of the first type makes it possible to establish an electrical link between the photovoltaic module and the first adjacent photovoltaic module to an inactive configuration in which the possibility of establishing the electrical link is disabled,
wherein the rotary element consists of a mobile part of the electrical connector of the first type mounted to pivot so that the switchover of the electrical connector of the first type from one configuration to the other is effected by a pivoting movement of the mobile part of the electrical connector of the first type over a given angular travel, the active configuration corresponding to a first angular position of the mobile part in which an electrical connection is established between the photovoltaic module and the electrical connector of the first type and the inactive configuration corresponding to a second angular position of the mobile part in which said electrical connection is not established.

2. Module according to claim 1, comprising a first electrically conductive element, arranged so as to establish the electrical connection between the photovoltaic module and the mobile part of the electrical connector of the first type in the first angular position of the mobile part of the electrical connector of the first type.

3. Module according to claim 1,
wherein the electrical connector of the first type comprises a fixed part mounted on a rest of the photovoltaic module so as to be rotationally immobile about a pivoting axis of the mobile part of the electrical connector of the first type, and
wherein the module comprises a first airtight and watertight sealing means interposed between the mobile part of the electrical connector of the first type and the fixed part of the electrical connector of the first type and a second airtight and watertight sealing means interposed between the fixed part of the electrical connector of the first type and the rest of the photovoltaic module.

4. Module according to claim 1, wherein a pivoting axis of the mobile part of the electrical connector of the first type is at right angles to directions corresponding to a length and to a width of the photovoltaic module.

5. Module according to claim 1, comprising an electrical connector of the second type arranged so as to be able to cooperate with the electrical connector of the first type of a second adjacent photovoltaic module and establish an electrical link with the second adjacent photovoltaic module.

6. Module according to claim 5, wherein the electrical connector of the second type comprises a pivotingly mobile part mounted to pivot relative to the photovoltaic module over a given angular travel so that the electrical connector of the second type varies, by pivoting of said mobile part, between:
an active configuration adopted in a first angular position of said mobile part in which the electrical connector of the second type makes it possible to establish an electrical link between the photovoltaic module and the second adjacent photovoltaic module and in which an electrical connection is established between the photovoltaic module and the electrical connector of the second type,
and an inactive configuration adopted in a second angular position of the mobile part in which the possibility of establishing the electrical link between the photovoltaic module and the second adjacent photovoltaic module is disabled and in which the electrical connection between the photovoltaic module and the electrical connector of the second type is not established.

7. Module according to claim 5, comprising a second electrically conductive element arranged so as to establish the electrical connection between the photovoltaic module and the mobile part of the electrical connector of the second type in a first angular position of the mobile part of the electrical connector of the second type.

8. Module according to claim 5,
wherein the electrical connector of the second type comprises a fixed part mounted on a rest of the photovoltaic module so as to be rotationally immobile about a pivoting axis of the mobile part of the electrical connector of the second type, and
wherein the module comprises a third airtight and watertight sealing means interposed between the mobile part of the electrical connector of the second type and the fixed part of the electrical connector of the second type and a fourth airtight and watertight sealing means interposed between the fixed part of the electrical connector of the second type and the rest of the photovoltaic module.

9. Module according to claim 5, wherein a pivoting axis of the mobile part of the electrical connector of the second type is at right angles to directions corresponding to a length and to a width of the photovoltaic module.

10. Module according to claim 1, wherein at least one of (i) the electrical connector of the first type and (ii) the electrical connector of the second type is arranged on a frame encircling the photovoltaic module.

11. Module according to claim 10, wherein the frame comprises a recess in which is housed at least one of (i) the electrical connector of the first type and (ii) the electrical connector of the second type.

12. Photovoltaic installation, comprising the photovoltaic module according to claim 1 and the first adjacent photovoltaic module, and arranged adjacent to one another, the module comprising the electrical connector of the first type and the first adjacent photovoltaic module comprising the electrical connector of the second type, the installation varying between a first electrical configuration in which an electrical link is established between the photovoltaic module and the first adjacent photovoltaic module adopted in the active configuration of the electrical connector of the first type and when the electrical connector of the first type and the electrical connector of the second type are in physical and electrical contact, and a second electrical configuration the electrical link is not established between the photovoltaic module and the first adjacent photovoltaic module adopted in at least one of (i) in the inactive configuration of the electrical connector of the first type and (i) when the electrical connector of the first type and the electrical connector of the second type are not in physical and electrical contact.

13. Installation according to claim 12,
wherein in the first electrical configuration of the installation, the mobile part of the electrical connector of the first type occupies the first angular position in which an electrical connection is established between the photovoltaic module and the electrical connector of the first type,
wherein the mobile part of the electrical connector of the second type occupies the first angular position in which an electrical connection is established between the first photovoltaic module and the electrical connector of the second type and the mobile part of the electrical connector of the first type and the mobile part of the electrical connector of the second type are in physical and electrical contact, and,
wherein in the second electrical configuration of the installation, at least one of (i) the mobile part of the electrical connector of the first type occupies the second angular position in which the electrical connection is not established between the photovoltaic module and the electrical connector of the first type, (ii) the mobile part of the electrical connector of the second type occupies the second angular position in which the electrical connection is not established between the first adjacent photovoltaic module and the electrical connector of the second type and (iii) the mobile part of the electrical connector of the first type and the mobile part of the electrical connector of the second type are not in physical and electrical contact.

14. Installation according to claim 12, wherein the photovoltaic module and the first adjacent photovoltaic module respectively comprise first and second joining elements independent of the electrical connector of the first type and the electrical connector of the second type cooperating with one another so as to mechanically mutually secure together or detach the photovoltaic module and the first adjacent photovoltaic module depending on a relative positioning so that a pivoting axis of the mobile part of the electrical connector of the first type is aligned with a pivoting axis of the mobile part of the electrical connector of the second type.

15. Installation according to claim 14, wherein the electrical connector of the first type and the electrical connector of the second type are arranged so that an implementation of a mechanical detachment between the photovoltaic modules by the first and second joining elements automatically provokes the switchover of the installation to the second electrical configuration.

16. Installation according to claim 14, wherein the first and second joining elements can mechanically secure the photovoltaic module and the first adjacent photovoltaic module together independently of a choice of the first electrical configuration and the second electrical configuration of the installation.

17. Installation according to claim 12,
wherein the electrical connector of the first type comprises an actuation member accessible from outside the photovoltaic module and arranged so as to allow an application to said actuation member of a driving force provoking a pivoting movement of the mobile part of the electrical connector of the first type from the second angular position to the first angular position and
wherein the electrical connector of the first type and the electrical connector of the second type comprise cooperation elements, ensuring that said pivoting movement of the mobile part of the electrical connector of the first type provokes a pivoting movement of the mobile part of the electrical connector of the second type from a second angular position to a first angular position, the mobile part of the electrical connector of the second type being driven by the mobile part of the electrical connector of the first type at a level of said cooperation elements.

18. Installation according to claim 17,
wherein the mobile part of the electrical connector of the first type is mounted to slide along a pivoting axis of the mobile part so as to be able to be translated over a sliding travel in opposition to an action of a first return element of the module stressing said mobile part to a rest position and
wherein the electrical connector of the first type is arranged so that the pivot-wise driving of the mobile part of the electrical connector of the first type by the actuation member is conditional on an implementation of a sliding movement of the mobile part of the electrical connector of the first type from the rest position.

19. Installation according to claim 18,
wherein the mobile part of the electrical connector of the second type is mounted to slide along a pivoting axis of the mobile part so as to be able to be translated over a sliding travel in opposition to an action of a second return element of the first adjacent photovoltaic module stressing said mobile part towards a rest position and
wherein the electrical connector of the first type and the electrical connector of the second type ensure that the sliding movement of the mobile part of the electrical connector of the first type from the rest position provokes a sliding movement of the mobile part of the electrical connector of the second type from a rest position, the pivot-wise driving of the mobile part of the electrical connector of the second type by the mobile part of the electrical connector of the first type being conditional on an implementation of the sliding movement of the mobile part of the electrical connector of the second type from the rest position.

20. Module according to claim 7, wherein the second electrically conductive element is a second electrically conductive blade.
